(19) United States
(12) Patent Application Publication
(10) Pub. No.: US 2017/0184516 A1
(43) Pub. Date: Jun. 29, 2017

(54) PORTABLE BACKSCATTER IMAGING INSPECTION APPARATUS AND IMAGING METHOD

(71) Applicant: Nuctech Company Limited, Beijing (CN)

(72) Inventors: Zhiqiang Chen, Beijing (CN); Yuanjing Li, Beijing (CN); Ziran Zhao, Beijing (CN); Wanlong Wu, Beijing (CN); Yingkang Jin, Beijing (CN); Le Tang, Beijing (CN); Xiao Tang, Beijing (CN); Guangwei Ding, Beijing (CN)

(73) Assignee: Nuctech Company Limited, Beijing (CN)

(21) Appl. No.: 15/285,850

(22) Filed: Oct. 5, 2016

(30) Foreign Application Priority Data
Dec. 25, 2015 (CN) 201510996664.2

(51) Int. Cl. G01N 23/203

(52) U.S. Cl. CPC G01N 23/203; G01N 2223/053; G01N 2223/408

(57) ABSTRACT

The present disclosure relates to a portable backscatter imaging inspection apparatus and an imaging method thereof, the apparatus comprising: an apparatus housing, an X-ray source, a rotating modulation mechanism, a radiation detector, a motion sensor and a controller; the X-ray source, the rotating modulation mechanism, the radiation detector and the motion sensor are disposed within the apparatus housing, wherein the radiation detector is used to receive scatter signal data from a surface of an object under inspection to form a two dimensional (2D) image, the motion sensor is used to collect a three dimensional (3D) motion track and scanning angles of the apparatus during a scanning process, the controller is used to splice and fuse a plurality of 2D images received by the radiation detector based on the 3D motion track and the scanning angles to obtain a stereo image of the surface of the object under inspection. This disclosure may achieve a better scan imaging effect on an object having a curved surface or multiple irregular surfaces.

### TECHNICAL FIELD

This disclosure relates to the field of X-ray imaging applications, particularly to a portable backscatter imaging inspection apparatus and an imaging method.

### BACKGROUND

X-ray backscatter imaging technology is an imaging technique capable of obtaining a substance image within a certain depth under an object's surface through detecting the strength of X-ray scattering from different substances. An imaging apparatus implementing X-ray backscatter imaging is generally provided with a radiation source and a detector system, wherein X-rays emitted from the radiation source pass through a rotating modulation mechanism and form a beam to carry out point-by-point scanning on a surface of an object under inspection; the detector system receives signals scattered back from the object and generates a depth image under the object's surface according to the signals.

Currently, systems adopting such imaging apparatuses are mostly applied to fixed security inspection apparatuses for containers, vehicles, persons and packages, i.e., the security inspection apparatus is fixed in a position and a target under inspection moves to complete passing-through inspection. This method requires that the target under inspection keeps a certain distance from the device, and imaging only can be performed at a constant angle, therefore, it has limitations on the range of applications of those security inspection apparatuses.

With the development of radiation source and detector techniques, miniaturized and portable backscatter devices have been emerged. Current portable backscatter imaging apparatuses may be put close to targets under inspection to realize multi-angle multi-azimuth imaging of the targets under inspection. Meanwhile, these backscatter imaging apparatuses are light and portable, and are beneficial to sufficiently expanding their application scenarios. However, in general, these backscatter imaging apparatuses are only suitable for scan imaging of objects having planar surfaces, for objects having curved surfaces or multiple irregular surfaces, their scan imaging effect is unsatisfied and it is difficult to clearly identify overall and practical interior situations of objects under inspection from the generated depth images, resulting in limitation on the range of applications of these backscatter imaging apparatuses.

### SUMMARY

The object of this disclosure is to provide a portable backscatter imaging inspection apparatus and imaging method, capable of producing a better scan imaging effect on an object having a curved surface or multiple irregular surfaces.

In order to realize the above object, a portable backscatter imaging inspection apparatus is provided in this disclosure, comprising: an apparatus housing, an X-ray source, a rotating modulation mechanism, a radiation detector, a motion sensor and a controller. The rotating modulation mechanism, the X-ray source, the radiation detector and the motion sensor are fixed disposed within the apparatus housing, wherein a receiving surface of the radiation detector is located at a front end of the apparatus housing, and is used to receive scatter signal data of a surface of an object under inspection to form a two dimensional (2D) image, the motion sensor is used to collect a three dimensional (3D) motion track and scanning angle of the portable backscatter imaging inspection apparatus during a scanning process, the controller is signaling connected to the radiation detector and the motion sensor, and is used to splice and fuse a plurality of 2D images received by the radiation detector to obtain a stereo image of the surface of the object under inspection based on the 3D motion track and the scanning angles.

Further, the motion sensor comprises an accelerometer and a gyroscope, wherein the accelerometer is used to measure the magnitude and direction of velocity and acceleration of the portable backscatter imaging inspection apparatus during the scanning process, the gyroscope is used to measure pitch, heading, and roll components of 3D rotation of the portable backscatter imaging inspection apparatus during the scanning process; 3D positions of the portable backscatter imaging inspection apparatus in various instants during the scanning process are obtained according to collaborated measurements of the accelerometer and the gyroscope to form the 3D motion track, and scanning angles of the receiving surface of the radiation detector faces toward the surface of the object under inspection in various instants are determined.

Further, the controller is further used to perform an image aspect ratio correction on a scanned 2D image according to the magnitude and direction of velocity and acceleration of the portable backscatter imaging inspection apparatus during the scanning process that are measured by the accelerometer.

Further, the controller is further used to perform a stretch or affine correction on the scanned 2D image according to the magnitude and direction of velocity and acceleration of the portable backscatter imaging inspection apparatus during the scanning process that are measured by the accelerometer, and the pitch, heading, and roll components of 3D rotation of the portable backscatter imaging inspection apparatus during the scanning process that are measured by the gyroscope.

Further, the controller is further used to splice and fuse a plurality of 2D images scanned by the radiation detector based on the 2D motion track of the portable backscatter imaging inspection apparatus to obtain a planar image of the surface of the object under inspection according to the magnitude and direction of velocity and acceleration of the portable backscatter imaging inspection apparatus during the scanning process that are measured by the accelerometer.

Further, the apparatus further comprises a monitor disposed on one side of the apparatus housing apart from the radiation detector, and the monitor is used to receive the stereo image of the surface of the object under inspection sent from the controller and display the stereo image.

In order to realize the above object, an imaging method based on the above portable backscatter imaging inspection apparatus is further provided in this disclosure, comprising:

emitting an X-ray beam from an X-ray source, scanning a surface of an object under inspection by means of a rotating modulation mechanism, and receiving scatter signal data of the surface of the object under inspection by a radiation detector to form a 2D image;

during a scanning process, collecting a 3D motion track and scanning angles of the portable backscatter imaging inspection apparatus by the motion sensor;

splicing and fusing, by a controller, a plurality of 2D images received by the radiation detector to obtain a stereo image of the surface of the object under inspection based on the 3D motion track and scanning angles collected by the motion sensor.

Further, the motion sensor comprises an accelerometer and a gyroscope, wherein collecting a 3D motion track and scanning angles of the portable backscatter imaging inspection apparatus by the motion sensor comprises:

measuring the magnitude and direction of velocity and acceleration of the portable backscatter imaging inspection apparatus during the scanning process by the accelerometer, and measuring pitch, heading, and roll components of 3D rotation of the portable backscatter imaging inspection apparatus by the gyroscope;

obtaining 3D positions of the portable backscatter imaging inspection apparatus in various instants during the scanning process according to collaborated measurements of the accelerometer and the gyroscope to form the 3D motion track, and determining scanning angles of a receiving surface of the radiation detector faces toward the surface of the object under inspection in various instants.

Further, the method further comprises:

according to the magnitude and direction of velocity and acceleration of the portable backscatter imaging inspection apparatus during the scanning process that are measured by the accelerometer, performing an image aspect ratio correction on a scanned 2D image by the controller.

Further, the method further comprises:

according to the magnitude and direction of velocity and acceleration of the portable backscatter imaging inspection apparatus during the scanning process that are measured by the accelerometer, and the pitch, heading, and roll components of 3D rotation of the portable backscatter imaging inspection apparatus measured by the gyroscope, performing a stretch or affine correction on the scanned 2D image by the controller.

Further, the method further comprises:

according to the magnitude and direction of velocity and acceleration of the portable backscatter imaging inspection apparatus during the scanning process that are determined by the accelerometer, splicing and fusing a plurality of 2D images scanned by the radiation detector to obtain a planar image of the surface of the object under inspection by the controller based on the 2D motion track of the portable backscatter imaging inspection apparatus.

Further, the portable backscatter imaging inspection apparatus further comprises a monitor disposed on one side of the apparatus housing apart from the radiation detector, the imaging method further comprises:

receiving, by the monitor, the stereo image of the surface of the object under inspection sent from the controller and displaying the stereo image.

In addition, a computer device is further provided in this disclosure, comprising a memory, and a processor coupled to the memory; the processor is configured to perform a method based on the program stored in the memory according to the imaging method based on the above portable backscatter imaging inspection apparatus.

In addition, a computer-readable storage medium which stores computer program is further provided in this disclosure, the program is executed by a processor to implement the method according to the imaging method based on the above portable backscatter imaging inspection apparatus.

With the above technical solution, the portable backscatter imaging inspection apparatus of this disclosure is provided with motion sensor capable of collecting its own 3D motion track and scanning angles during a scanning process, so that the controller may form a stereo backscatter image representing a surface of an object under inspection according to a plurality of 2D images received by the radiation detector, a 3D motion track and scanning angles, to solve the problem of scan-imaging an object under inspection having a curved surface or multiple irregular surfaces by the portable backscatter imaging apparatus, thereby a more comprehensive and intuitive representation of the inner structure and information of the object under inspection may be achieved.

### BRIEF DESCRIPTION OF THE DRAWINGS

Drawings illustrated herein, which are part of this application, are provided for a better understanding of the disclosure, in which:

FIG. 1 is an external structure diagram of the portable backscatter imaging inspection apparatus according to one embodiment of this disclosure.

FIG. 2 is an internal structure diagram of the embodiment of FIG. 1.

FIG. 3 is a flow chart of the imaging method of the portable backscatter imaging inspection apparatus according to one embodiment of this disclosure.

FIG. 4 is a flow chart of the imaging method of the portable backscatter imaging inspection apparatus according to another embodiment of this disclosure.

### DETAILED DESCRIPTION

The present disclosure will be further illustrated below in details in conjunction with the accompanying drawings with exemplary embodiments. It is to be understood that the following Detailed Description is merely exemplary, rather than to limiting the present disclosure inappropriately.

It is to be understood that the following Detailed Description to at least one exemplary embodiment is merely illustrative, rather than to being any limitation to the present disclosure and its any applications/usages.

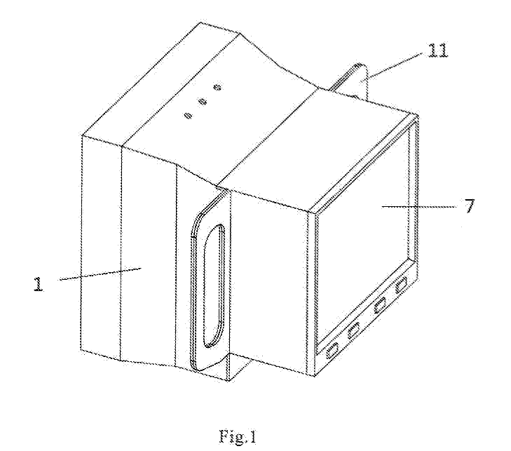

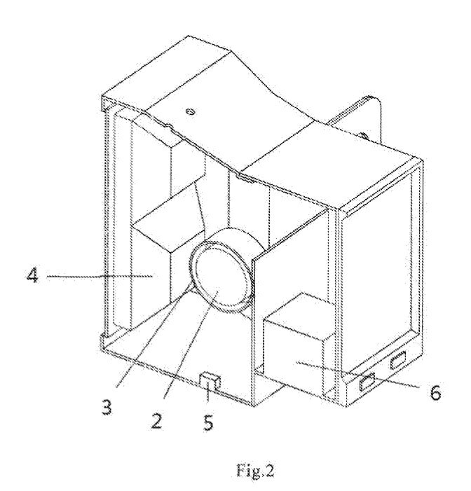

FIG. 1 is an external structure diagram of the portable backscatter imaging inspection apparatus according to one embodiment of this disclosure. In combination with the internal structure shown in FIG. 2, the portable backscatter imaging inspection apparatus of this embodiment comprises: an apparatus housing 1, an X-ray source 2, a rotating modulation mechanism 3, a radiation detector 4, a motion sensor 5 and a controller 6. The X-ray source 2, the rotating modulation mechanism 3, the radiation detector 4 and the motion sensor 5 are fixed disposed within the apparatus housing 1. A receiving surface of the radiation detector 4 is located at a front end of the apparatus housing 1, and is used to receive scatter signal data of a surface of an object under inspection to form a 2D image.

The motion sensor 5 is used to collect a 3D motion track and scanning angles of the portable backscatter imaging inspection apparatus during a scanning process, the controller 6 is signaling connected to the radiation detector 4 and the motion sensor 5, and is used to splice and fuse a plurality of 2D images received by the radiation detector 4 based on the 3D motion track and the scanning angles to obtain a stereo image of the surface of the object under inspection.

In this embodiment, the X-ray source 2 emits X-rays at a large field angle, the X-rays are modulated to a high-speed rotating beam by the rotating modulation mechanism 3 and projected on a surface of an object under inspection and reciprocally move along a straight line to perform one-dimensional scanning. An operator holds a handheld apparatus and attaches the portable backscatter imaging inspection apparatus on the surface of the object under inspection, moves in a direction perpendicular to the projection movement direction, so that the projected beam scans an area having a width, and a 2D image having a depth is formed.

The X-ray source 2, the rotating modulation mechanism 3 and the radiation detector 4 are all conventional devices used for backscatter imaging. To enable the motion sensor 5 to accurately measure a 3D motion track and scanning angles of the portable backscatter imaging inspection apparatus, the motion sensor 5, the X-ray source 2, the rotating modulation mechanism 3 and the radiation detector 4 must be fixed within the apparatus housing 1 together while remaining relatively static with respect to each other.

The controller 6 may be disposed within the apparatus housing 1 as shown in FIG. 2, for example, on one inner side of the apparatus housing 1 apart from the radiation detector, or may be disposed at any suitable locations within the apparatus housing 1. In another embodiment, the controller may be provided externally, or its functions may be realized using an external or remote control system.

For the convenience of holding the portable backscatter imaging apparatus, at least one handle may be provided on the outer side of the apparatus housing 1, for example, FIG. 1 shows handle 11 for forward holding with left and right hands. The handle 11 may facilitate a continuous scanning action, and may enable to apply pressure on the surface of the object under inspection, to ensure that the receiving surface of the radiation detector 4 is tightly attached on the surface of the object under inspection.

When a user carries out backscatter scanning on an object under inspection, scanning is performed continuously along the surface of the object under inspection with the portable backscatter imaging apparatus (hereinafter, the apparatus) held by the user. This scanning may be continued no matter whether the object under inspection has a curved surface or multiple surfaces to be scanned. During the scanning process, in every instant (every point in time at which signal data corresponding to a scanned image is obtained), there is a 3D location point and a scanning angle value corresponding to the apparatus; this information is recorded by the motion sensor. A 3D motion track of the apparatus may be obtained according to these 3D location points. In the process of generating a surface image of the object under inspection, in association with scanning angles of the radiation detector when 2D images are received, image splicing and fusing may be performed according to this information to form a stereo image of the surface of the object under inspection. Thus, the problem of backscatter scanning and imaging of an object under inspection having a plurality of surfaces or a curved surface may be solved, a more comprehensive and intuitive representation of the inner structure and information of the object under inspection may be achieved. Consequently, the application range of the apparatus is expanded, the capability of representing the structure and information of an object under inspection of the apparatus may be improved, and the function of information integration of the apparatus is enhanced.

The motion sensor 5 preferably is six-axis sensor, including but not limited to an accelerometer and a gyroscope. Other currently available sensors that can obtain a 3D motion track and scanning angles may be used as well. The accelerometer is used to measure the magnitude and direction of velocity and acceleration of the portable backscatter imaging inspection apparatus during the scanning process, and the gyroscope is used to measure pitch, heading, and roll components of 3D rotation of the portable backscatter imaging inspection apparatus. With collaborated measurements of the accelerometer and the gyroscope, 3D positions of the apparatus in various instants during the scanning process may be obtained to form the 3D motion track, and scanning angles in various instants at which the receiving surface of the radiation detector 4 faces toward the surface of the object under inspection are determined.

The user may scan in a linear reciprocating arc scan manner. Because it is difficult for the user to accurately keep the uniformity of velocity in different movement directions while scanning the object under inspection with the handheld apparatus, it is liable to scan sometimes too fast and sometimes too slow, so that images obtained in this manner always suffer from a stretched aspect ratio or other distortions. Thus, the accelerometer may be used to detect the placement state of the apparatus, and the controller 6 may correct the image aspect ratio of an obtained 2D image according to the magnitude and direction of velocity and acceleration of the apparatus that are measured by the accelerometer during the scanning process. Further, speed variation or rotation may occur during the movement of the handheld apparatus. In this case, the detection functions of the accelerometer and the gyroscope may be used, so that the controller 6 may perform a stretch or affine correction on an obtained 2D image according to the magnitude and direction of velocity and acceleration of the apparatus process that are measured by the accelerometer during the scanning, and pitch, heading, and roll components of 3D rotation of the apparatus measured by the gyroscope.

In addition to an object under inspection having a curved surface or a plurality of surfaces, the portable backscatter imaging inspection apparatus of this disclosure is also applicable to backscatter imaging inspection of an object having a larger surface to be scanned. In this process, the controller mainly depends on the magnitude and direction of velocity and acceleration of the apparatus that are measured by the accelerometer during a scanning process to splice and fuse a plurality of 2D images scanned by the radiation detector 4 based on the 2D motion track of the apparatus to obtain a planar image of the object under inspection.

A monitor 7 may be further provided on one side of the apparatus housing 1 apart from the radiation detector 4, which is used to receive a stereo image of the surface of the object under inspection sent from the controller 6 and display the stereo image. In another embodiment, the monitor 7 may be a device provided separately from the portable backscatter imaging inspection apparatus, or may be integrated in an external or remote control system. A scan image may be displayed on the monitor 7 as a strip representation.

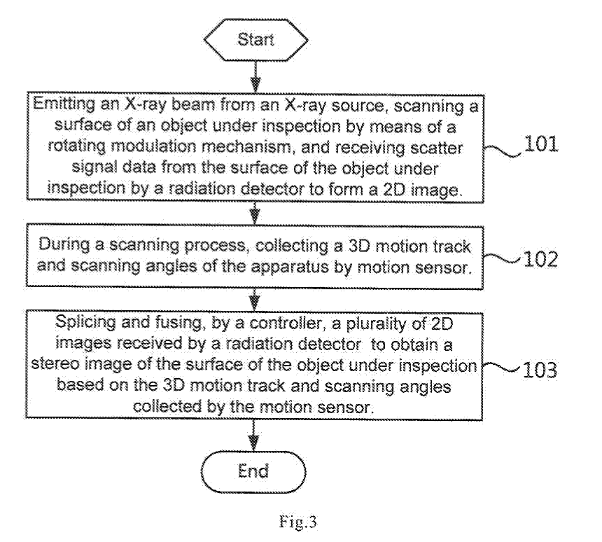

Based on the above embodiments of the portable backscatter imaging inspection apparatus, an imaging method is further provided in this disclosure. FIG. 3 is a flow chart of the imaging method based on the portable backscatter imaging inspection apparatus according to one embodiment of this disclosure. In this embodiment, the imaging method comprises:

at step 101, emitting an X-ray beam from an X-ray source 2, scanning a surface of an object under inspection by means of a rotating modulation mechanism 3, and receiving scatter signal data from the surface of the object under inspection by a radiation detector 4 to form a 2D image;

at step 102, during a scanning process, collecting a 3D motion track and scanning angles of a portable backscatter imaging inspection apparatus by the motion sensor 5;

at step 103 splicing and fusing, by a controller 6, a plurality of 2D images received by a radiation detector 4 based on the 3D motion track and scanning angles collected by the motion sensor 5 to obtain a stereo image of the surface of the object under inspection.

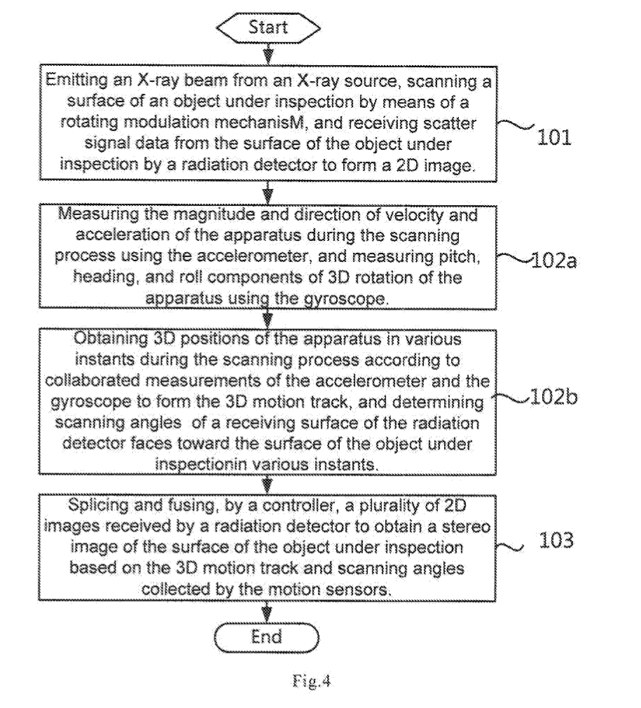

FIG. 4 is a flow chart of the imaging method based on the portable backscatter imaging inspection apparatus according to another embodiment of this disclosure. Compared with the above embodiment, the motion sensor 5 of this embodiment comprises an accelerometer and a gyroscope. Step 102 particularly comprises:

step 102a: measuring the magnitude and direction of velocity and acceleration of the portable backscatter imaging inspection apparatus during the scanning process using the accelerometer, and measuring pitch, heading, and roll components of 3D rotation of the portable backscatter imaging inspection apparatus using the gyroscope;

step 102b: obtaining 3D positions of the portable backscatter imaging inspection apparatus in various instants during the scanning process according to collaborated measurements of the accelerometer and the gyroscope to form the 3D motion track, and determining scanning angles in various instants, at which a receiving surface of the radiation detector 4 faces toward the surface of the object under inspection.

In another embodiment, the imaging method further comprises a step of performing an image aspect ratio correction on a scanned 2D image using a controller 6, according to the magnitude and direction of velocity and acceleration of the portable backscatter imaging inspection apparatus during the scanning process that are measured by the accelerometer.

In still another embodiment, the imaging method further comprises a step of performing a stretch or affine correction on the scanned 2D image using the controller 6, according to the magnitude and direction of velocity and acceleration of the portable backscatter imaging inspection apparatus during the scanning process that are measured by the accelerometer, and the pitch, heading, and roll components of 3D rotation of the portable backscatter imaging inspection apparatus measured by the gyroscope during the scanning process.

In still another embodiment, the imaging method may further comprises a step of splicing and fusing a plurality of 2D images scanned by the radiation detector 4 based on the 2D motion track of the portable backscatter imaging inspection apparatus to obtain a planar image of the surface of the object under inspection using the controller 6, according to the magnitude and direction of velocity and acceleration of the portable backscatter imaging inspection apparatus during the scanning process that are measured by the accelerometer.

With respect to the apparatus embodiment in which a monitor 7 is provided on one side of the apparatus housing 1 apart from the radiation detector 4, the imaging method further comprises a step of receiving a stereo image of the object under inspection sent from the controller 6 and displaying the stereo image on the monitor 7.

Those skilled in the art will appreciate that contents of the apparatus and method involved in the present disclosure are correlated with each other, especially the description of some functions and effects of the method is also applicable to the description of the apparatus, and thus will not be repeated in detail.

Furthermore, the method according to the disclosure may be also implemented as a computer program product comprising a computer readable medium on which a computer program for performing the functions defined in the method of the disclosure is stored. The skilled in the art would appreciate that, the various illustrative logical blocks, modules, circuits and algorithm steps could be implemented as an electronic hardware, computer software or a combination thereof.

Although some particular embodiments of this disclosure have been illustrated in detail, those skilled in the art may understand that the above exemplary embodiments are merely illustrative, rather than to being any limitation to the scope of this disclosure, and various changes or modifications may be effected to above embodiments by those skilled in the art without departing from the scope and spirit of this disclosure as defined in the appended claims.

1. A portable backscatter imaging inspection apparatus, wherein comprising: an apparatus housing, an X-ray source, a rotating modulation mechanism, a radiation detector, a motion sensor and a controller; the X-ray source, the rotating modulation mechanism, the radiation detector and the motion sensor are fixed disposed within the apparatus housing, wherein a receiving surface of the radiation detector is located at a front end of the apparatus housing, and is used to receive scatter signal data of a surface of an object under inspection to form a two dimensional (2D) image, the motion sensor is used to collect a three dimensional (3D) motion track and scanning angles of the portable backscatter imaging inspection apparatus during a scanning process, the controller is signaling connected to the radiation detector and the motion sensor, and is used to splice and fuse a plurality of 2D images received by the radiation detector to obtain a stereo image of the surface of the object under inspection based on the 3D motion track and the scanning angles.

2. The portable backscatter imaging inspection apparatus according to claim 1, wherein the motion sensor comprises an accelerometer and a gyroscope, wherein the accelerometer is used to measure the magnitude and direction of velocity and acceleration of the portable backscatter imaging inspection apparatus during the scanning process, the gyroscope is used to measure pitch, heading, and roll components of 3D rotation of the portable backscatter imaging inspection apparatus during the scanning process; 3D positions of the portable backscatter imaging inspection apparatus in various instants during the scanning process are obtained according to collaborated measurements of the accelerometer and the gyroscope to form the 3D motion track, and scanning angles of the receiving surface of the radiation detector faces toward the surface of the object under inspection in various instants are determined.

3. The portable backscatter imaging inspection apparatus according to claim 2, wherein the controller is further used to perform an image aspect ratio correction on a scanned 2D image, according to the magnitude and direction of velocity and acceleration of the portable backscatter imaging inspection apparatus during the scanning process that are measured by the accelerometer.

4. The portable backscatter imaging inspection apparatus according to claim 2, wherein the controller is further used to perform a stretch or affine correction on the scanned 2D image, according to the magnitude and direction of velocity and acceleration of the portable backscatter imaging inspection apparatus during the scanning process that are measured by the accelerometer, and the pitch, heading, and roll components of 3D rotation of the portable backscatter imaging inspection apparatus that are measured by the gyroscope.

5. The portable backscatter imaging inspection apparatus according to claim 2, wherein the controller is further used to splice and fuse a plurality of 2D images scanned by the radiation detector based on the 2D motion track of the portable backscatter imaging inspection apparatus to obtain a planar image of the surface of the object under inspection, according to the magnitude and direction of velocity and acceleration of the portable backscatter imaging inspection apparatus during the scanning process that are measured by the accelerometer.

6. The portable backscatter imaging inspection apparatus according to claim 1, wherein further comprising a monitor disposed on one side of the apparatus housing apart from the radiation detector, and the monitor is used to receive the stereo image of the surface of the object under inspection sent from the controller and display the stereo image.

7. An imaging method based on portable backscatter imaging inspection apparatus, wherein:
emitting an X-ray beam from an X-ray source, scanning a surface of an object under inspection by means of a rotating modulation mechanism, and receiving scatter signal data of the surface of the object under inspection by a radiation detector to form a 2D image;
during a scanning process, collecting a 3D motion track and scanning angles of the portable backscatter imaging inspection apparatus by motion sensor;
splicing and fusing, by a controller, a plurality of 2D images received by the radiation detector to obtain a stereo image of the surface of the object under inspection based on the 3D motion track and scanning angles collected by the motion sensor.

8. The imaging method according to claim 7, wherein the motion sensor comprise an accelerometer and a gyroscope, wherein collecting a 3D motion track and scanning angles of the portable backscatter imaging inspection apparatus by the motion sensor comprises:
measuring the magnitude and direction of velocity and acceleration of the portable backscatter imaging inspection apparatus during the scanning process using the accelerometer, and measuring pitch, heading, and roll components of 3D rotation of the portable backscatter imaging inspection apparatus using the gyroscope;
obtaining 3D positions of the portable backscatter imaging inspection apparatus in various instants during the scanning process according to collaborated measurements of the accelerometer and the gyroscope to form the 3D motion track, and determining scanning angles in various instants, at which a receiving surface of the radiation detector faces toward the surface of the object under inspection.

9. The imaging method according to claim 8, wherein:
according to the magnitude and direction of velocity and acceleration of the portable backscatter imaging inspection apparatus during the scanning process that are measured by the accelerometer, performing an image aspect ratio correction on a scanned 2D image by the controller.

10. The imaging method according to claim 8, wherein:
according to the magnitude and direction of velocity and acceleration of the portable backscatter imaging inspection apparatus during the scanning process that are measured by the accelerometer, and the pitch, heading, and roll components of 3D rotation of the portable backscatter imaging inspection apparatus measured by the gyroscope, performing a stretch or affine correction on the scanned 2D image by the controller.

11. The imaging method according to claim 8, wherein:
according to the magnitude and direction of velocity and acceleration of the portable backscatter imaging inspection apparatus during the scanning process that are determined by the accelerometer, splicing and fusing a plurality of 2D images scanned by the radiation detector based on the 2D motion track of the portable backscatter imaging inspection apparatus to obtain a planar image of the surface of the object under inspection by the controller.

12. The imaging method according to claim 7, wherein the portable backscatter imaging inspection apparatus further comprises a monitor disposed on one side of the apparatus housing apart from the radiation detector, the imaging method further comprising:
receiving, by the monitor, the stereo image of the surface of the object under inspection sent from the controller and displaying the stereo image.

13. A computer device, wherein:
a memory, and;
a processor coupled to the memory;
the processor is configured to perform a method based on the program stored in the memory according to claim 7.

14. A computer readable storage medium which stores computer program, wherein the program is executed by a processor to implement the method according to claim 7.
